(19) United States
(12) Patent Application Publication
(10) Pub. No.: US 2003/0102347 A1
(43) Pub. Date: Jun. 5, 2003

(54) Portable personal tape dispenser/protector

(76) Inventor: Scot G. Caviness, Vero, FL (US)

Correspondence Address: SHAHNDA CAVIESS, 740 35TH AEVNUE SW, VERO BEACH, FL, 32968, US

(21) Appl. No.: 10/012,107

(22) Filed: Dec. 4, 2001

(51) Int. Cl. B26F 3/02

(52) U.S. Cl. 225/43; 225/47; 225/26

(57) ABSTRACT

A portable wearable adhesive or other type tape roll dispenser that may be intended to dispense a single or multiple tape rolls. The dispenser has an enclosed housing and a cap that covers the area where the tape passes from the housing and beyond the area where the tape is separated from the tape roll or rolls. The dispenser can be worn on a belt or carried an equipment and completely protects the tape product from foreign object damage.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO MICROFICHE APPENDIX

Not Applicable.

### BACKGROUND OF THE INVENTION

The invention relates to portable adhesive tape dispensers that function as tape protectors, specifically dispensers/protectors that have the ability to be easily carried and readily dispense and sever lengths of tape as needed and to protect the tape roll's freshly y exposed tape end.

Adhesive tape such as electrical friction, masking, scotch type and other tapes such as electrical wire marking and security tape are widely used in numerous facets of todays society.

Originally these tapes were and many are still used without the aid of a dispensing system. In addition, with the exception of medical tapes most tapes lack protective devices and are subject to abrasions and contaminants that can render an entire roll of tape unfit for use. In some cases such as with electrical tape and electrical wire marking tapes abrasions and contaminants can lead to catastrophic failure of the bonding adhesive which can further lead to unintended electrical short circuits and electrical ground faults, thus causing fire, loss of property and life.

As an improvement inventors have created numerous portable tape dispensers which aid the user in extracting and severing a length of tape. Furthermore, U.S. Pat. No. 4,880,152 to Trankle and U.S. Pat. No. 5,961,066 to Hambleton detail wrist held portable tape dispensers which allow the user to extract and separate a length of tape with one hand while holding an object in the other, possibly to be taped.

U.S. Pat. No. D 369,385 to Lapointe, U.S. Pat. No. D 428,922 to Packard et al. and U.S. Pat. NO. D 448,416 to Kimura claim tape dispensers that are mostly enclosed providing a good amount of protection to the tape roll.

U.S. Pat. No. 4,735,351 to Biswas and U.S. Pat. No. 4,252,258 to Plummer detail inventions capable of holding, dispensing, cutting off and holding a tape roll's tape end ready for the next use. These inventions are also capable of being carried and both are intended to make available multiple tape rolls for use.

From the body of prior art it is obvious that the inventions designed as wearable tape dispensers do not completely protect the tape products from foreign contaminants and/or abrasions. And those inventions which do completely protect the tape products are not specifically intended to be wearable.

### BRIEF SUMMARY OF THE INVENTION

The present invention comprises a device designed for and having the capability to be loaded with one or more rolls of tape which can be easily carried and that can readily dispense and sever lengths of tape as needed.

The present invention is new and solves a real world need because the above common features are combined with a closure which completely shields the tape product(s), including the tape end(s) from foreign contaminants. In addition the present invention accomplishes these goals without the complicated components found in many of the prior art devices.

### OBJECTS AND ADVANTAGES

Accordingly, the objects and advantages of my above titled patent are;

(a) to provide a tape housing which prevents foreign objects from contaminating housed material(s),

(b) to provide a tape housing which prevents foreign objects from cutting or abrading a tape roll,

(c) to provide a tape housing which allows easy access to a tape roll's tape end(s),

(d) to provide a tape housing which facilitates the clean and easy separation of a length of tape from a tape roll, or a plurality of tape rolls, and

(e) to provide a tape housing which is easy to store and carry.

Further objects and advantages are to provide a tape housing that ensures at least one housed tape roll will be maintained and dispensed in a manner most advantageous to the tape product's protection thus reducing the possibility of electrical and/or other hazards due to impaired or damaged tape products.

### BRIEF DESCRIPTION OF THE SEVERAL VIEWS OF THE DRAWINGS

FIG. 1 is a right side view of the main housing.

FIG. 2 is a front view of the main housing.

FIG. 3 is a back view of the main housing.

FIG. 4 is a perspective view of the main housing.

FIG. 5 is a perspective view of the tape roll bearing race.

FIG. 6 is a side view of the tape roll bearing race.

FIG. 7 is an end view of the tape roll bearing race.

FIG. 8 is a perspective view of the cutoff snap-cap.

FIG. 9 is a left end view of the cutoff snap-cap.

FIG. 10 is a right end view of the cutoff snap-cap.

FIG. 11 is a right side view of the front cover cover plate.

FIG. 12 is a front view of the front cover cover plate.

FIG. 13 is a back view of the front cover cover plate.

FIG. 14 is a perspective view of the lock screw.

FIG. 15 is a side view of the lock screw.

FIG. 16 is an exploded perspective view of a tape roll's positioning on the tape roll bearing race and their fitment into the main housing.

FIG. 17 is a perspective view of the main housing and tape roll bearing race with a roll of tape installed.

FIG. 18 is an exploded view of the cutoff snap-cap, front cover cover plate and lockscrew fitment.

FIGS. 19-24 are frontal views which detail the use of the invention.

FIG. 19 shows cutoff snap-cap being opened.

FIG. 20 shows a tape roll's tape end being grasped.

FIG. 21 shows a length of tape being extracted.

FIG. 22 shows the tape being secured on the tape holding area.

FIG. 23 shows the cutoff snap-cap closed causing tape length separation.

FIG. 24 shows tape length separation.

### DETAILED DESCRIPTION OF THE INVENTION

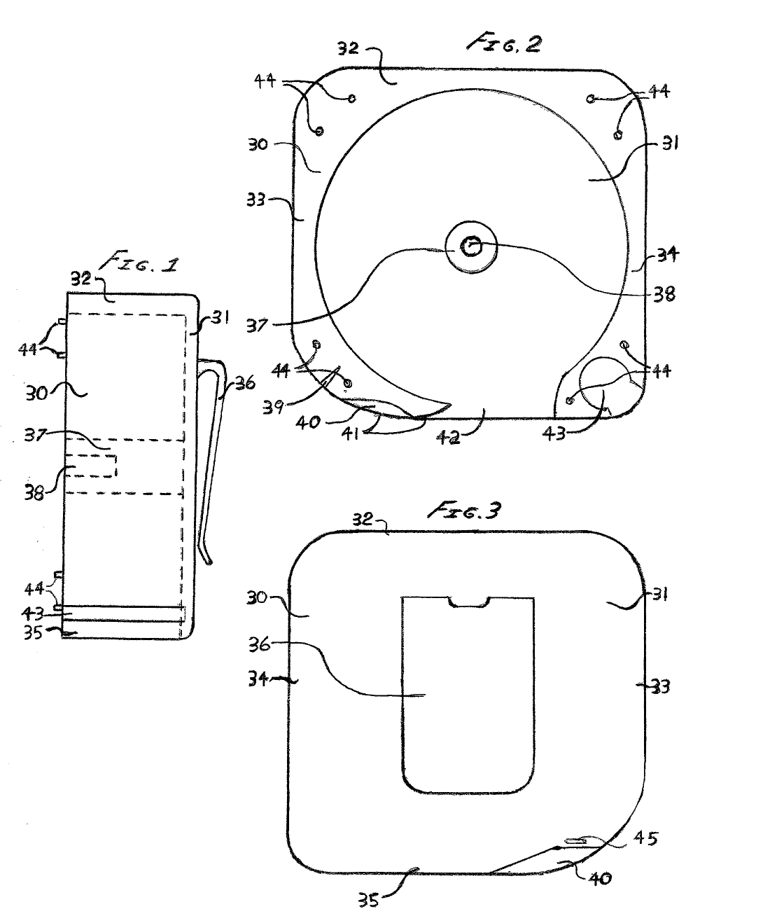

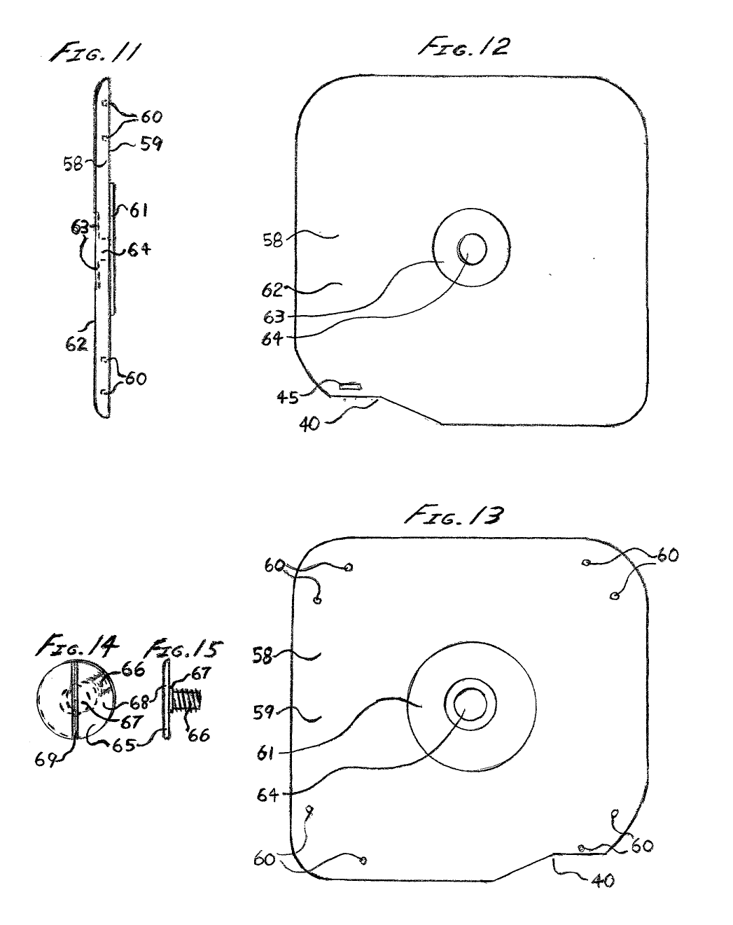

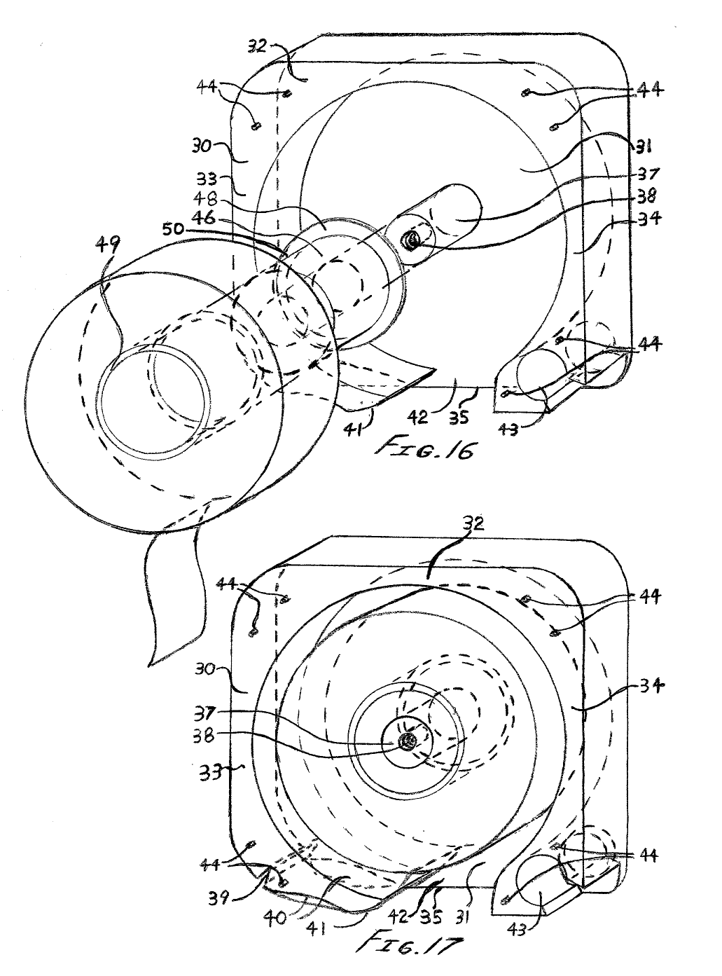

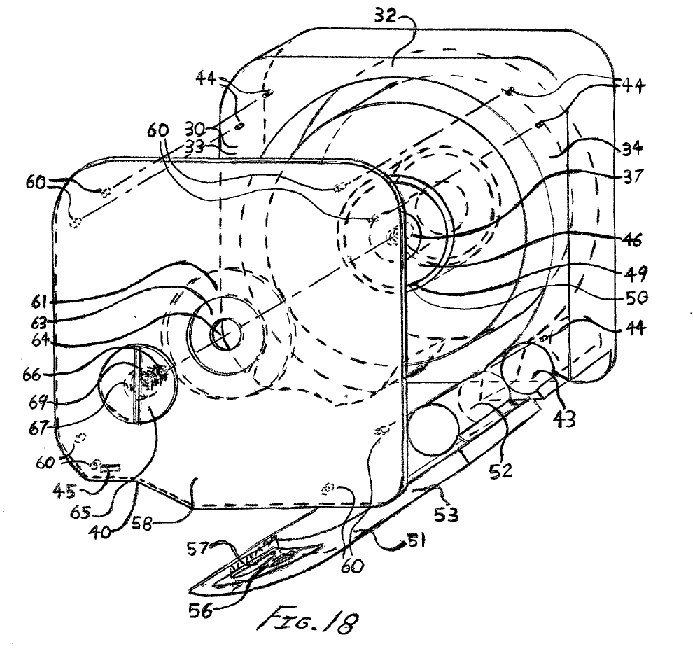

A preferred embodiment of the present invention and its use is illustrated in FIGS. 1-24.

Referring more particularly to FIGS. 1-4, the preferred embodiment has a main housing 30 that is comprised of a back area 31 and a raised edge having a top 32, a left side 33, a right side 34, and a bottom 35. This single piece of injection molded, machined or otherwise constructed material has a carrying clip or other carrying means 36 attached on the outer side of the upper back (FIGS. 1 and 3) and a cylindrical shaft bearing piece 37 protrudes forward from the inner back wall of said main housing (FIGS. 1, 2 and 4). The shaft bearing peace has a threaded recess 38 in the center of the front facing end (FIGS. 1, 2, and 4).

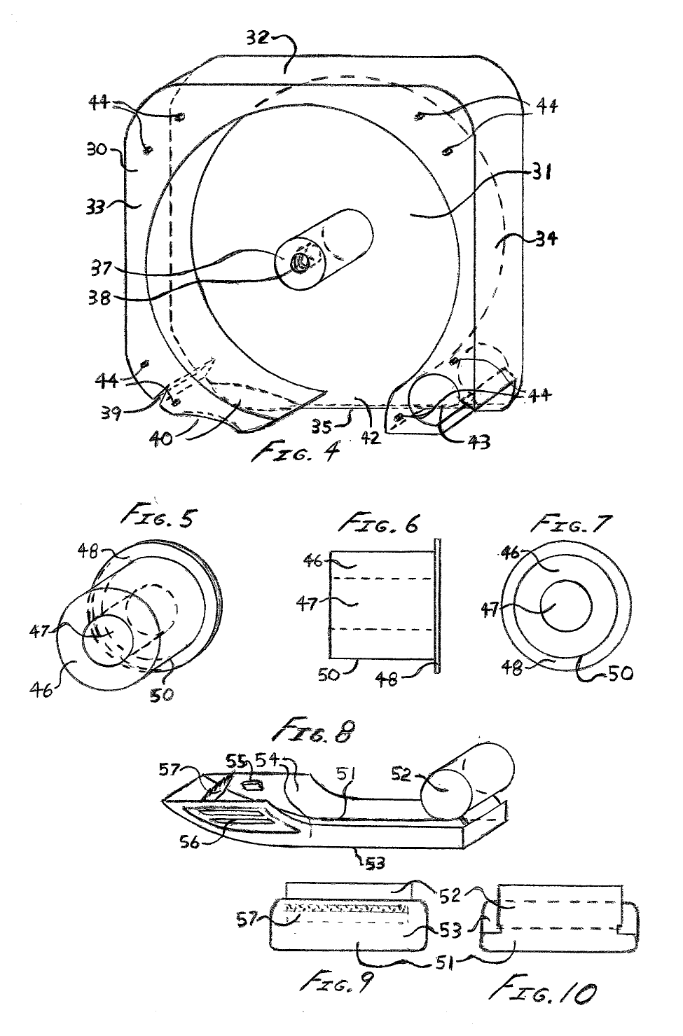

The bottom edge of the main housing 35 contains a tape cutoff slot 39, two tape pull recesses 40, a tape end holding area 41, a tape transfer slot 42 and a cylindrical cutoff snap-cap swivel bearing cavity 43 that is open at the main housing's front and partially open on the right and bottom edge corner (FIGS. 2 and 4). On the front face of the raised edges are front cover cover plate alignment pins 44, and on the lower back and lower front area of the front cover cover plate 58 there is a set of cutoff snap-cap closure indentures 45.

Referring now more particularly to FIGS. 5-7, integral to the present embodiment is a cylindrical tape roll bearing race 46 having an inner bore 47 slightly larger than the main housing's shaft bearing piece's 37 outer diameter. The back side of the tape roll bearing race has a raised tape roll flange 48 that extends to an outer diameter that is larger than the intended tape product's inner diameter 49. In addition the main area of the tape bearing race's outer diameter 50 is of a size to firmly hold the intended tape product's inner diameter 49.

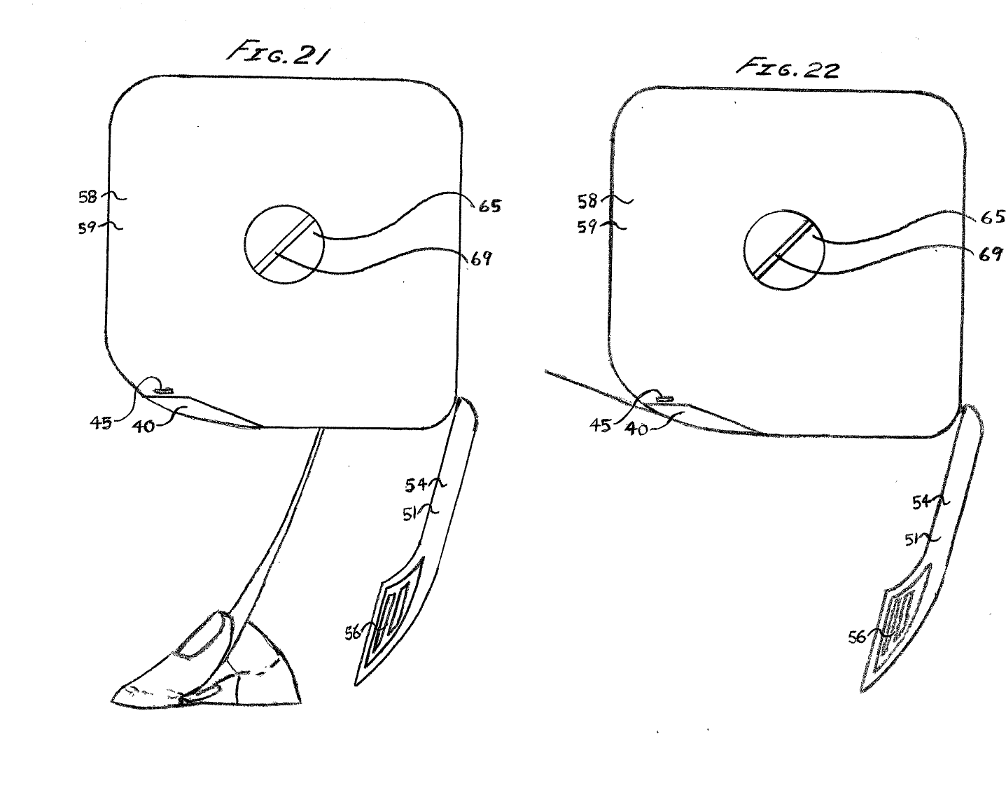

Referring now to FIGS. 8-10, integral to the present embodiment is a tape end protector cutoff snap-cap 51 here after referred to as the cutoff snap-cap which has a swivel bearing end 52 that is slightly smaller in circumference than the main housing's swivel bearing cavity 43. Attached to this is a cover piece 53 having a length and width to cover the bottom edge of the main housing and possessing raised edges 54 that cover a portion of the main housing's lower back and the front cover cover plate's lower area (FIG. 19). On the interior facing raised edges of the cutoff snap-cap there are a set of cutoff snap-cap closure nodes 55 oriented to align with the cutoff snap-cap closure indentures 45 and on the exterior of the cutoff snap-cap's raised edges are gripping aids 56. Opposite the swivel bearing end of the cutoff snap-cap is a tape cutoff extrusion 57 having a sufficiently angled edge to cleanly sever the intended tape product.

Referring now to FIGS. 11-13 and also integral to the present embodiment is a front cover cover plate 58. The back or inner facing side of the front cover cover plate 59 has alignment pin holes 60 that correspond to the main housings alignment pins 44 and a centrally located circular tape bearing race spacer extrusion 61 protrudes inward having an inner diameter slightly larger than the cylindrical shaft bearing piece 37, and an outside diameter similar to the outside diameter of the tape bearing race's raised tape roll flange 48. The front side of the front cover cover plate 62 has a centrally located recessed circular indenture 63 and centered in this is a lock screw hole 64 having a diameter slightly larger than the cylindrical shaft bearing's threaded recess 38.

Referring now to FIGS. 14 and 15, and also integral to the present embodiment is an assembly lock screw 65 hereafter referred to as a lock screw which has a threaded end 66 which corresponds to the cylindrical shaft bearing's threaded recess 38. Adjoining the threaded end is an unthreaded length 67 having a diameter slightly smaller than the front cover cover plate's lock screw hole 64 and a length equal to the thickness of the front cover cover plate minus the thickness of the centrally located circular indenture 63. This unthreaded length further adjoins the lock screw's cap 68 which has a diameter slightly less and a thickness slightly thinner than the front cover cover plate's centrally located circular indenture 63. The lock screw's cap also has a slotted indenture 69 traversing the frontal face.

### USE OF INVENTION

The manner of using the claimed invention's preferred embodiment may first entail the loading of tape into the invention.

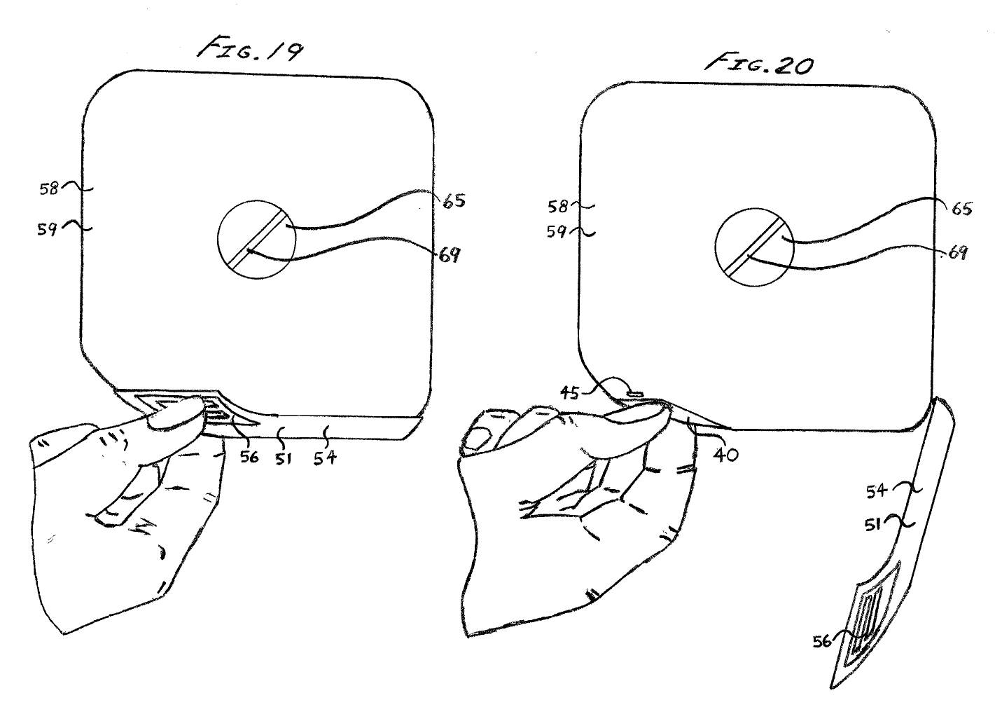

Referring now to FIG. 16, load an appropriate roll of tape onto the tape roll bearing race 46 ensuring that the tape roll is oriented to unroll in a clockwise direction relative to the invention. Insert the frontal end of the tape roll bearing race 46 through the back of the tape roll's center 49 until the tape roll is seated firmly against the tape roll bearing race flange 48.

Referring now to FIG. 17, free approximately four or five inches of tape from the tape roll and install tape 49 and tape roll bearing race 46 onto the tape roll bearing shaft ensuring that the free tape end is passed through the main housing's tape transfer area 42. Said free 4 or 5 inches of tape should then be adhered to the tape end holding area 41.

Referring now to FIG. 18, the front cover cover plate 58 should be installed ensuring that the front cover cover plate alignment pins 44 are properly aligned with their corresponding front cover cover plate alignment pin holes 60. With the front cover cover plate 58 seated, install the lock screw 65 by inserting the lock screw into centrally located lock screw hole 64 in front cover cover plate 58 where it engages the shaft bearing's threaded recess 38 and rotate lock screw in a clockwise direction utilizing a screw driver or other means until lock screw is firmly seated.

Referring now to FIGS. 23 and 24, once invention is assembled operator should close cutoff snap-cap 51 and remove excess tape end that may protrude from cutoff snap-cap.

With the invention loaded with tape product it can be used as follows:

Referring now to FIGS. 2, 3 and 19-24,

1. Carry invention utilizing one or more carrying means 36 (FIGS. 1 and 3).

2. Open tape end protector cutoff snap-cap 51 and swivel open utilizing the snap-cap gripping aides 56 (FIG. 19).

3. Insert a finger and or thumb into one or both tape pull recesses 40 and pull tape end down freeing said tape end from the tape end holding area 41 (FIG. 20).

4. Extract length of tape desired by pulling tape end down making allowance for the tape length required to run from the tape transfer area 42 to the tape cutoff slot 39 (FIG. 21)

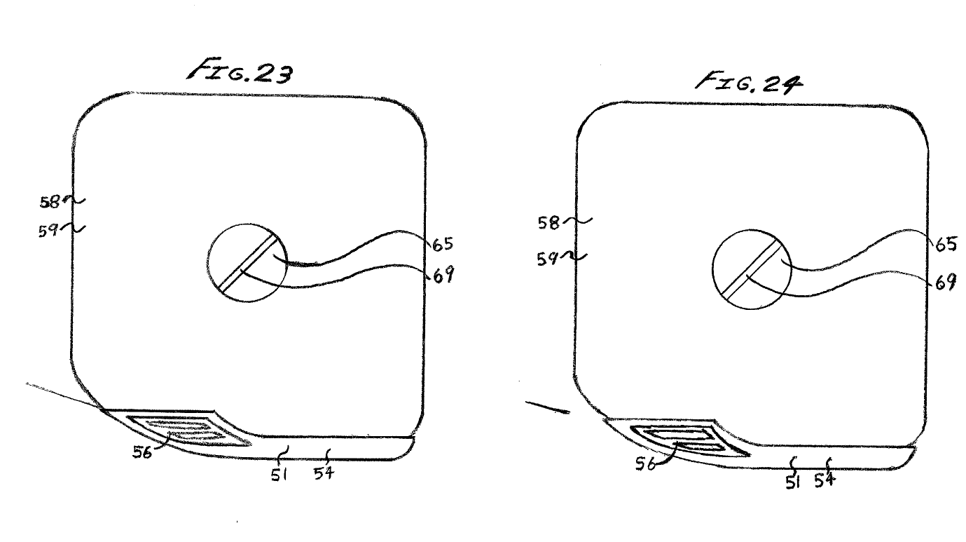

5. Raise extracted tape length causing the portion of said tape length closest to the tape roll to become adhered to the tape end holding area 41 (FIG. 22).

6. Close tape end protector cutoff snap-cap 51 by swivelling cap up until the snap-cap closure nodes 55 engage whereby the cutoff extrusion 57 will have caused extracted tape length to separate.

I Claim:

1. A hand held portable wearable adhesive tape roll or plurality of adhesive tape rolls protector that functions as a dispenser comprising;
a main housing means that encloses at least one roll of adhesive tape that protects said tape roll from contaminants and abrasions;
at least one centrally located tape roll bearing means to facilitate at least one tape roll's rotation within said main housing means;
a tape feed transfer area means whereby a tape roll's tape end can feed out of the main housing means;
a tape end holding area means such as the main housing's bottom surface to securely hold at least one tape roll's tape end in a position ready for use;
at least one tape end lifting means such as indentures or tape pull recesses that undercut said tape end holding area means to facilitate the lifting of the tape roll's tape end from the tape end holding area means;
a tape end severing slot means that will accept a severing extrusion means to allow for the easy separation of at least one length of tape from at least one tape roll;
a cover means that protects the tape feed transfer area means the tape end holding area means and the tape end lifting means that prevents contaminants and abrading objects from contacting housed tape materials that can be easily opened to facilitate the extraction of a length of tape from at least one tape roll end and that upon closing will cleanly sever a length of tape from at least one tape roll; and
at least one carrying means whereby a person can attach the present invention onto his or her person or equipment to allow ready access and hands free carrying.

2. A tape dispenser as defined in claim one above comprising a specific multiple of the above detailed features to allow for the dispensing of a specific multiple rolls of adhesive backed or other tape roll products.
